(19) United States
(12) Patent Application Publication
(10) Pub. No.: US 2014/0238771 A1
(43) Pub. Date: Aug. 28, 2014

(54) MARINE ACOUSTIC PROJECTOR PISTON FOR VIBRATOR SOURCE ELEMENT AND METHOD

(71) Applicant: CGG SERVICES SA, Massy Cedex (FR)

(72) Inventors: Benoit TEYSSANDIER, Massy (FR); Robert DOWLE, Massy (FR); Dominique THOMAS, Gif-Sur-Yvette (FR)

(73) Assignee: CGG SERVICES SA, Massy Cedex (FR)

(21) Appl. No.: 14/172,008

(22) Filed: Feb. 4, 2014

Related U.S. Application Data
(60) Provisional application No. 61/767,855, filed on Feb. 22, 2013.

(51) Int. Cl. G01V 1/155; G06F 17/30

(52) U.S. Cl. CPC G01V 1/155; G06F 17/30
USPC 181/110; 703/1

(57) ABSTRACT

There is a method for determining a shape and structure of a piston for a vibratory seismic source element. The method includes generating a cost function J that is function of plural variables; applying plural constraints to the cost function J; calculating a piston shape and piston design that fulfills the plural constraints; and modifying the calculated piston shape and piston design based on practical implementations of the vibratory source element.

### BACKGROUND

1. Technical Field

Embodiments of the subject matter disclosed herein generally relate to methods and systems and, more particularly, to mechanisms and techniques for determining an efficient shape and configuration of a marine acoustic projector piston for a marine vibratory source element.

2. Discussion of the Background

Reflection seismology is a method of geophysical exploration to determine the properties of a portion of a subsurface layer in the earth, information that is especially helpful in the oil and gas industry. Marine reflection seismology is based on the use of a controlled source that sends energy waves into the earth. By measuring the time it takes for the reflections to come back to plural receivers, it is possible to estimate the depth and/or composition of the features causing such reflections. These features may be associated with subterranean hydrocarbon deposits.

For marine applications, sources are mainly impulsive (e.g., compressed air is suddenly allowed to expand). A source commonly used is air guns that produce a high amount of acoustic energy over a short time. Such a source is towed by a vessel either at the water surface or at a certain depth. Acoustic waves from an air gun propagate in all directions. The emitted acoustic waves' typical frequency range is between 6 and 300 Hz. However, the use of impulsive sources can pose certain safety and environmental concerns. Further, the directivity and frequency content of impulsive sources cannot be controlled after the source is deployed.

Thus, another class of sources that may be used is vibratory. Vibratory sources, including hydraulically-powered or pneumatically-powered sources and those employing piezoelectric or magnetostrictive material, have been used in marine operations. However, these sources have no large-scale use because some types have limited power, some types are unreliable due to the number of moving parts required to generate seismic waves and some types use a working fluid that may pose environmental hazards in some failure modes. A positive aspect of vibratory sources is that they can generate signals that include various frequency bands, commonly referred to as “frequency sweeps.” In other words, the frequency band of such sources may be better controlled, as compared to impulsive sources. Also, the directivity of a source array that includes plural source elements may be controlled.

One example of a reliable vibratory source element is described in U.S. patent application Ser. No. 13/415,216 (herein the '216 application), filed on Mar. 8, 2012, entitled “Source for Marine Seismic Acquisition and Method,” assigned to the same assignee as the present application, the entire content of which is incorporated herein by reference.

However, the shape and configuration of pistons displacing the water to generate acoustic waves have not been subject to much research and optimization, especially in the context of vibratory source arrays (i.e., when the piston of one source element is influenced by the behavior of the pistons of other source elements of the source array).

Thus, it is desirable to determine the shape of the piston and its configuration to maximize radiated power for a given injected force. Accordingly, it would be desirable to provide systems and methods that provide the best shape and configuration for vibratory source pistons.

### SUMMARY

According to one embodiment, there is a method for determining a shape and structure of a piston for a vibratory seismic source element. The method includes generating a cost function J that is function of plural variables; applying plural constraints to the cost function J; calculating a piston shape and piston design that fulfills the plural constraints; and modifying the calculated piston shape and piston design based on practical implementations of the vibratory source element.

According to another embodiment, there is a method for determining a shape and structure of a piston for a vibratory seismic source element. The method includes generating first and second cost functions J₁ and J₂; applying first and second constraints to the first and second cost functions J₁ and J₂, respectively; calculating first a piston shape that fulfills the first constraints; calculating second a structure of the piston that fulfills the second constraints and modifying the calculated piston shape and piston structure based on practical implementations of the vibratory source element.

According to yet another embodiment, there is a method of seismic acquisition including using a plurality of source elements in which at least one source element is equipped with an underwater acoustic piston having a stiff convex shell that has been optimized to reduce the combined driven mass, wherein the driven mass includes a combined structural actual mass and a radiation mass; shooting the at least one source element; recording seismic data generated by the at least one source element; and generating an image of a surveyed subsurface.

According to another embodiment, there is a method of seismic acquisition including using a plurality of source elements in which at least one source element is equipped with an underwater acoustic piston driven axially and having a stiff convex shell that has a radius of curvature within a range of 0.9 A to 1.3 A, where A is a radius of a projection of the piston in a plane; shooting the at least one source element; recording seismic data generated by the at least one source element; and generating an image of a surveyed subsurface based on the recorded seismic data.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a high-frequency source element;

FIG. 2 is a schematic diagram of a low-frequency source element;

FIGS. 3A-J are schematic diagrams of various piston profiles;

FIG. 4 is a graph representing a variation of a mechanical radiation mass with frequency;

FIG. 5 illustrates the dependence of the mechanical radiation mass on the piston's radius of curvature;

FIG. 6 illustrates the correlation between the radius of curvature, thickness and mass of the piston;

FIG. 7 illustrates the variation of the radiation, actual and total masses with curvature;

FIG. 8 illustrates the dependency of the type of material with other pistons' variables;

FIG. 9 is an overview of a piston according to an embodiment;

FIG. 10 is a cross-sectional view of a piston according to an embodiment;

FIG. 11 is a method for optimizing a shape and structure of a piston in a seismic source element;

FIGS. 12A-B illustrate a seismic source array;

FIG. 13 illustrates a multi-component source array;

FIG. 14 illustrates a curved streamer;

FIG. 15 is a flowchart of a method for acquiring seismic data with a source having an optimized piston; and

FIG. 16 is a schematic diagram of a control device for implementing methods as noted above.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a vibratory source element configured to generate acoustic energy in a marine environment. However, the embodiments to be discussed next are not limited to a marine environment; they may be applied to any type of source of seismic waves that uses moving pistons.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, the shape and configuration of a piston used to generate seismic waves underwater are determined so that piston volumetric displacement and radiated power are maximized. To achieve these features, the total piston mass of the source element, which includes a structural mass (actual mass) and a radiation mass (apparent mass), is evaluated and then optimized (e.g., minimized) as will be discussed later, based on the concept that maximum radiated power is obtained by minimizing the total piston mass.

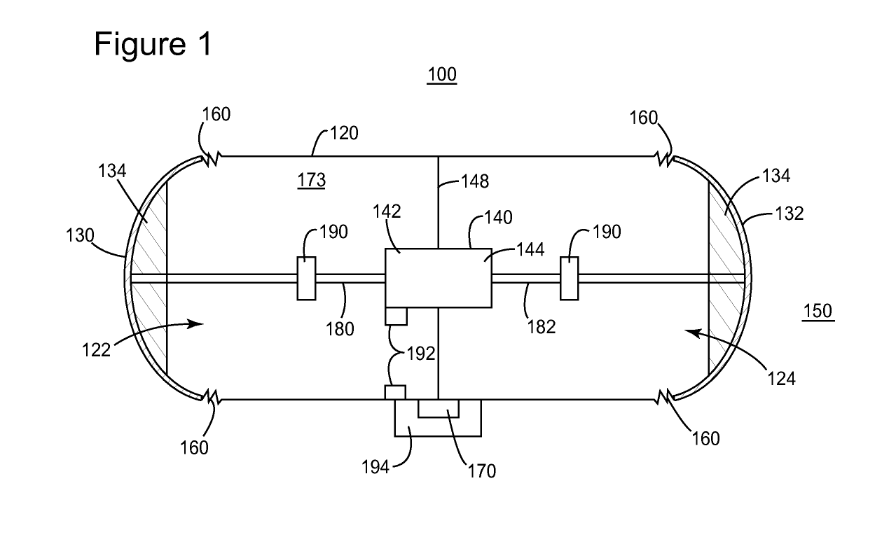

The structure of a vibratory source element is now discussed with regard to FIG. 1. A seismic vibro-acoustic source element is a unit capable of producing an acoustic wave. A source array may include one or more seismic vibro-acoustic source elements. For simplicity, a seismic vibro-acoustic source element is referred to, herein, as a “source element,” and the entire vibratory source array is referred to as a “source array.” A source element may have an electro-magnetic linear actuator system configured to drive a piston (or a pair of pistons). However, it is possible to have a hydraulic, pneumatic or piezoelectric actuator or other appropriate mechanisms instead of the electro-magnetic actuator. Each source element may be driven by an appropriate pilot signal. A pilot signal is designed as a source array target signal such that the total array far-field output follows a desired target power spectrum. A drive signal derived from the pilot signal is applied to each source element. A pilot signal may have any shape, e.g., pseudo-random, cosine or sine, increasing or decreasing frequency, etc.

According to the embodiment illustrated in FIG. 1, a source element 100 has a housing 120 that, together with pistons 130 and 132, enclose an actuator system 140 and separate it from the ambient 150, which might be water. Although FIG. 1 shows two movable pistons 130 and 132, note that a source element may have another number of pistons, e.g., one piston or more than two pistons.

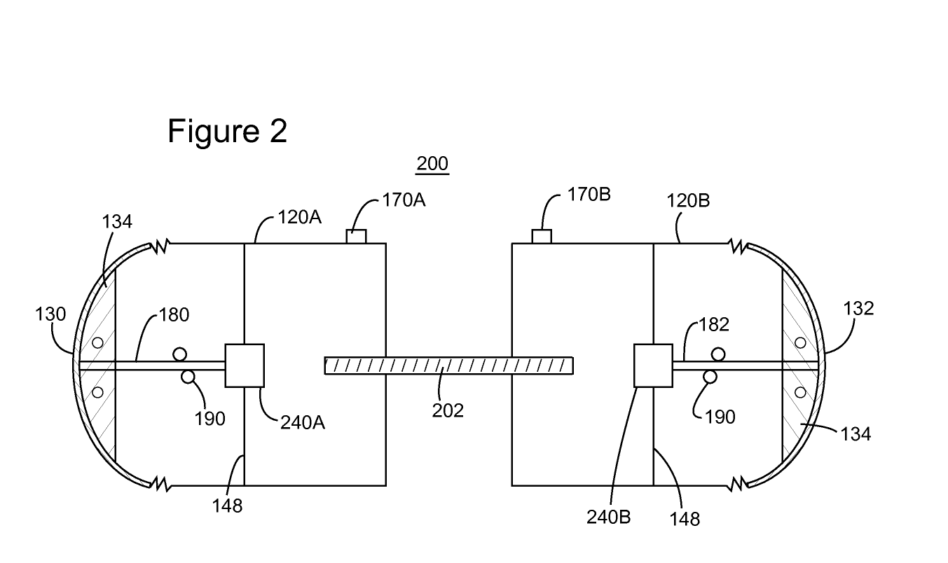

Housing 120 may be configured as a single enclosure as illustrated in FIG. 1 having first and second openings 122 and 124 configured to be closed by pistons 130 and 132. However, in embodiment 200 illustrated in FIG. 2, housing 120 may include two enclosures 120A and 120B rigidly connected to each other by a member 202. A single actuator system 140 may be configured to simultaneously drive pistons 130 and 132 in opposite directions for generating seismic waves, as illustrated in FIG. 1. Two actuator systems 240A and 240B may be used in the embodiment of FIG. 2. In one application, pistons 130 and 132 are rigid, i.e., made of a rigid material and reinforced, as will be discussed later, with rigid ribs 134. Actuator system 140 may include one or more individual electro-magnetic actuators 142 and 144. Other types of actuators may be used. Irrespective of how many individual actuators are used in source element 100 or 200, the actuators are provided in pairs, and the pairs are configured to act simultaneously in opposite directions on corresponding pistons in order to prevent a “rocking” motion of the source element. Note that it is undesirable to “rock” the source element when generating waves because the position of the source element should follow a predetermined path when towed in water.

The size and configuration of the housing, pistons and actuator system depend on the source element's acoustic output. For example, a high-frequency source element (as illustrated in FIG. 1) has smaller sizes than a low-frequency source element (as illustrated in FIG. 2). In one embodiment, the high-frequency source element's housing length is about 1.5 m and its diameter is about 450 mm. Total housing length of the low-frequency source element is about 3 m and its diameter is about 900 mm. Thus, in one application, low-frequency source elements are substantially double the size of high-frequency source elements.

Actuator system 140 may be attached to housing 120 by an attachment 148 (e.g., a wall or a bracket). Various other components that are described elsewhere are illustrated in FIGS. 1 and 2. Such components may include a sealing 160 provided between the pistons and the housing, a pressure regulation mechanism 170 configured to balance the external pressure of the ambient 150 with a pressure of a fluid 173 enclosed by housing 120 (enclosed fluid 173 may be air or other gases or mixtures of gases), one shaft (180 and 182) per piston to transmit the actuation motion from the actuation system 140 to pistons 130 and 132, a guiding system 190 for the shafts, a cooling system 194 to transfer heat from the actuator system 170 to ambient 150, a local control device 194 to coordinate the movement of these elements, etc.

To determine the shape and configuration (design) of pistons 130 and 132, the concept of mechanical radiation impedance (simply referred to as radiation impedance from now on) is introduced and applied. Radiation impedance relates to (i) the ability of an object to radiate acoustic energy into a fluid, e.g., water, and (ii) the fluid load induced by the shape of the object. Radiation impedance is defined as the ratio between the force applied by a vibrating object (e.g., piston) to a medium and the normal velocity of the object when moving that medium. For simplicity, the object is considered herein as the piston, and the medium the water. An integral of the fluid pressure over the 3-dimensional piston face in contact with the water needs to be performed when calculating the force for mechanical impedance.

The propagation medium (water in this case) has an effect on the piston's vibrating surface, which is related to radiation impedance. In particular, the water influences the piston in several ways, e.g., adding a damping effect and/or a mass effect. When calculated, the mechanical radiation impedance contains an imaginary part and a real part. The real part is called radiation damping and corresponds to the radiated energy. The radiated energy is the useful part of the work being done, while the imaginary part can be modeled as a radiation mass (not a real mass; this mass acts as a fluid mass added to the piston). Moving the radiation mass produces no real work, it just adds an extra load on the source element's actuator. If the actuator's force output is limited, which is normally the case, this in effect reduces the total acoustic energy the piston radiates. For the frequencies of interest, the diameter of the piston is small compared to a wavelength, and the imaginary part of the radiation impedance will be much larger than the real part.

Thus, it is desirable to reduce the radiation mass so that greater efficiency and greater acoustic output can be achieved. Radiation mass is linked to mechanical radiation impedance, as detailed in equation (1):

$${M}_{radiation} = \frac{Im ( {Z}_{R} )}{ω} , \qquad ( 1 )$$

where M_{radiation} is the radiation mass, Z_{R} is the acoustic impedance, Im( ) denotes the imaginary part of the argument and ω is the frequency. Therefore, by calculating the radiation impedance, it is possible to evaluate the radiation mass and other quantities of interest, e.g., radiation efficiency.

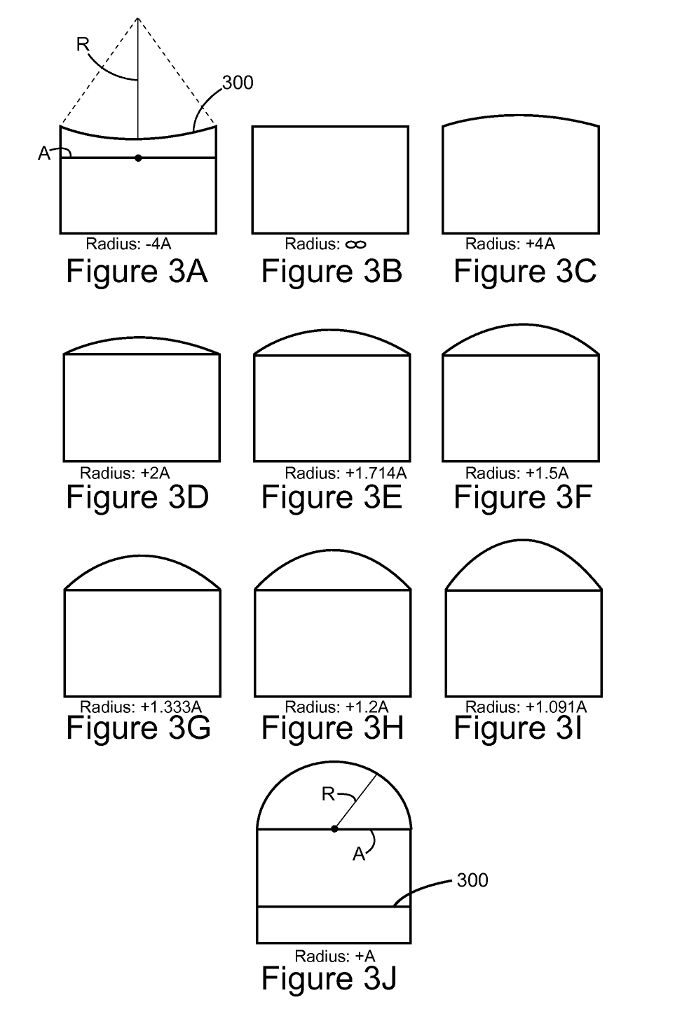

Various models have been used for performing the calculations, e.g., a finite element model and an analytical formulation. Because the results of these calculations were close, the finite element model has, consequently, been used for the remaining calculations. Multiple piston shapes have been investigated with the goal of minimizing total mass. To reduce possible piston shapes, it has been considered that a partly spherical shape would be most appropriate. Under this assumption, pistons whose profiles have different radius of curvature have been considered, and for each piston curvature, the corresponding radiation mass has been calculated. To ensure maximum acoustic radiation, one constraint was to obtain a rigid piston in the frequency band of interest, i.e., between 0 and 150 Hz. Bending modes for these shapes have been calculated, and a bending mode's minimum frequency should be greater than 150 Hz. A bending mode appears when the surface of the piston cannot maintain its shape and starts bending due to its load. Given a piston curvature, a minimum thickness of the piston has also been calculated with and without stiffeners (or ribs). For the optimization procedure that generates the piston configuration, a few piston radiuses of curvature have been chosen and are illustrated in FIGS. 3A-J. In these figures, R describes the curvature radius of the piston surface and A describes the radius of the piston transversal section 300, i.e., a projection of the piston in a horizontal plane in FIGS. 3A-J. By convention, for piston shapes that are concave R takes on a negative value as shown in FIG. 3A. For a flat piston face R=∞ as shown in FIG. 3B and for convex piston shapes R is a positive value as shown for FIGS. 3C-3J.

For the optimization calculations, a first cost function J₁ has been defined to depend on the radius of curvature R and the radiation mass. The constraint applied to J₁ is related to minimizing actual mass and maximizing the source element's energy output. In one application, actual mass includes only the piston mass. However, in another application, actual mass includes not only the piston's actual mass, but also the corresponding shaft and/or the guiding mechanism's actual mass.

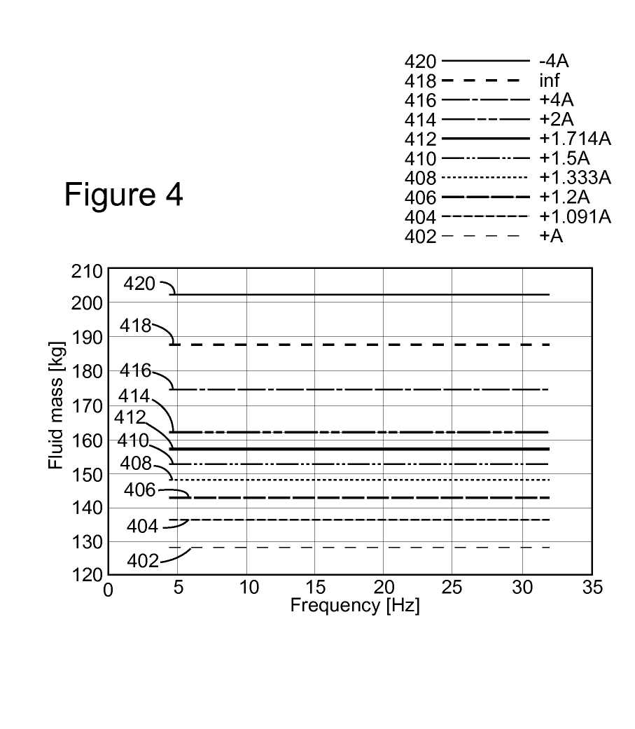

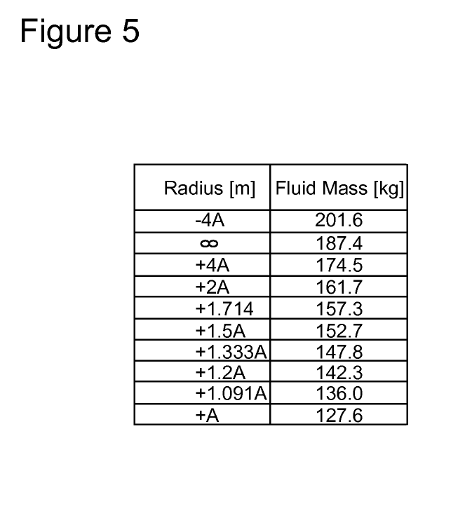

The results of these calculations are illustrated in FIG. 4, which shows radiation mass versus frequency for various piston radiuses of curvature. Each curve 402 to 420 is identified with a corresponding curvature radius expressed in terms of A (in this case, A=0.45 m). Note that the radiation mass is almost constant across the frequency range of interest in free field and under the assumption that the radiated wavelength is large enough compared to the source's dimensions, i.e., ka<<1, where a is the piston radius and k is the wavenumber. FIG. 5 summarizes radiation mass values as a function of the piston radius of curvature. Observe that for the convex piston shapes, the smaller the piston curvature radius, the smaller the radiation mass added to the structural mass (actual mass). This is so because a piston with a smaller radius of curvature encounters less water resistance, i.e., can easily penetrate the water. However, a small radius of curvature implies large actual mass for maintaining the sharp piston shape. Because the source element's total mass needs to be minimized, a compromise needs to be found between piston radius of curvature and actual mass to balance the piston shape with its total mass. Such a compromise has been found for the radius of curvature R to be in the range of 0.9 to 2 A. Thus, the piston's desired shape may be described as a stiff, convex surface that is part of a sphere and has a radius of about 0.9 to 1.3 A. In one embodiment, the radius of curvature R=A.

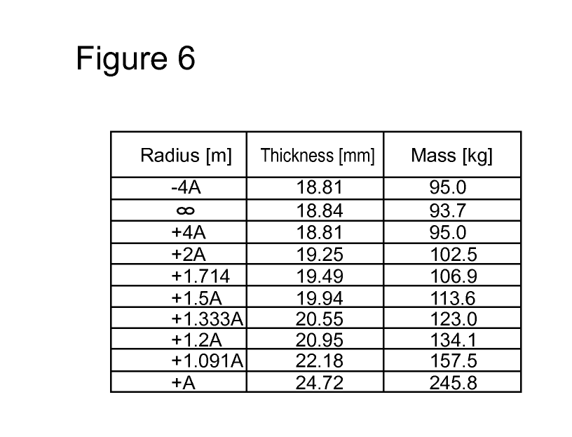

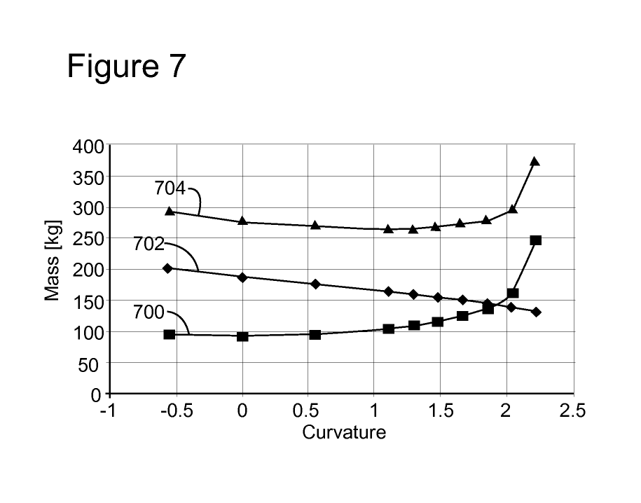

When piston thickness and mass are calculated for the radiuses noted in FIG. 3 (with no stiffeners), the results illustrated in FIG. 6 are obtained. Note that the mass illustrated in FIG. 6 is not the piston's actual mass, but just a tool for reaching a compromise between piston mass and radiation mass for selecting the piston shape. In other words, piston radius curvature is determined as a function of the thickness of the piston that withstands the bending mode, and mass is calculated based on the radius and thickness. However, this mass is not the piston's final actual mass. It is rather an intermediate mass associated with an intermediate shape corresponding to a virtual piston, and the final design of the piston is a variation of the virtual piston and takes into consideration other factors as hubs, beams, etc. that were ignored for the virtual piston. The final design is discussed and calculated later, by taking into account these other variables and constraints. FIG. 7 illustrates variation of the actual mass 700, radiation mass 702 and total mass 704 versus reciprocal of the radius of curvature for piston with A=0.45 m. As noted above, the actual and radiation mass have opposite behavior, i.e., the greater the piston curvature, the lower the radiation mass and the greater the piston's actual mass. Also note that these calculations take into consideration that the first bending mode for the low frequency piston is at about 100 Hz for all curves with no added stiffeners (ribs). Note that the addition of ribs will tend to increase the first bending mode frequency so that it is possible to achieve a first bending mode in excess of 150 Hz.

The above variables have been used to determine the piston's optimal shape. However, they are not the only ones used for selecting the piston's structure. Further variables are now discussed, and they are used to minimize the optimally-shaped piston's total mass. A second cost function J₂ may be used for this phase. Some of the variables used to build the cost function J₂ include, but are not limited to, the number of diametric stiffeners, stiffener thickness, piston thickness, the type of material, etc. A diametric stiffener is a rib that extends along the entire diameter of the piston's surface. A diametric stiffener is added to a piston not only to move resonant modes outside the driven frequency range, but also to resist the hydrostatic moment acting on the piston face due to the differences in hydrostatic pressure at the piston's top versus its bottom side if the piston face is vertically oriented. A large moment can produce a lot of stress near the point where the shaft connects to the piston, causing the piston to fail.

This second optimization process uses a cost function J₂, different from J₁, which include the variables noted above. The goal for cost function J₂ was to minimize the piston's actual mass while keeping the frequency of the first bending mode above 150 Hz. Those skilled in the art would recognize that there are many mathematical algorithms (e.g., least square method) for solving an optimization problem. For this case, a method as described in M. D. Nastran, “Design Sensitivity and Optimization User's Guide,” MSC.Software, Jun. 25, 2010, has been used, the entire content of which is incorporated herein by reference.

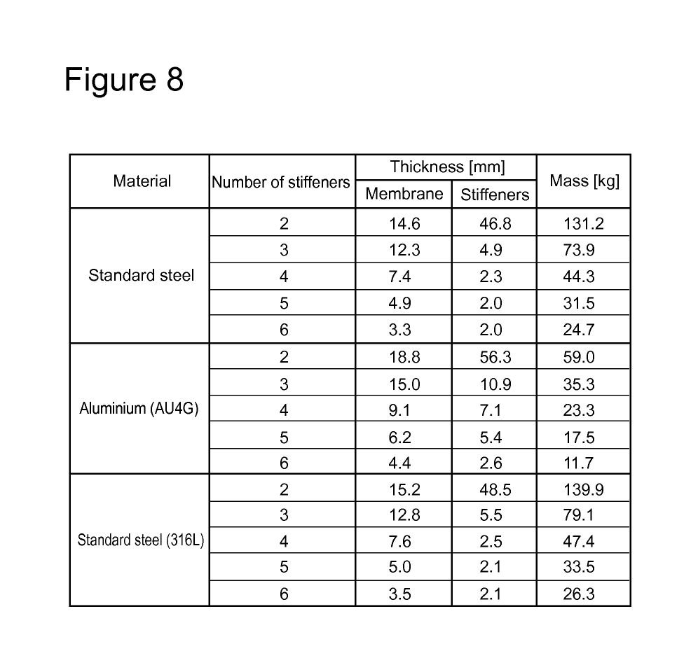

The number of stiffeners (one of the variables) ranged between 2 and 6, and the type of material (another variable) considered included standard steel, stainless steel and aluminum. Another variable was the stiffeners' thickness, and still another was the thickness of the piston's surface (i.e., membrane). Based on these variables, the optimization process produced the results summarized in FIG. 8. These results indicate that the piston's smallest actual mass is obtained when six stiffeners are used and the piston is made of aluminum.

However, the optimization process did not end with these calculations. Practical considerations for implementing the source elements were also considered, and they played a role in deciding the piston's final structure. For example, because aluminum does not easily attach to other materials, stainless steel was selected. Also, because high-frequency and low-frequency source elements have different requirements, it was decided to use three stiffeners for the low-frequency source element (whose piston has a large diameter, as discussed with FIG. 2) and no stiffeners for the high-frequency source element (whose piston has a small diameter, as discussed with FIG. 1) due to high actual mass optimization constraint. Also, because of the high-frequency source element piston's small diameter, it was decided to use a composite material instead of the materials noted in FIG. 8.

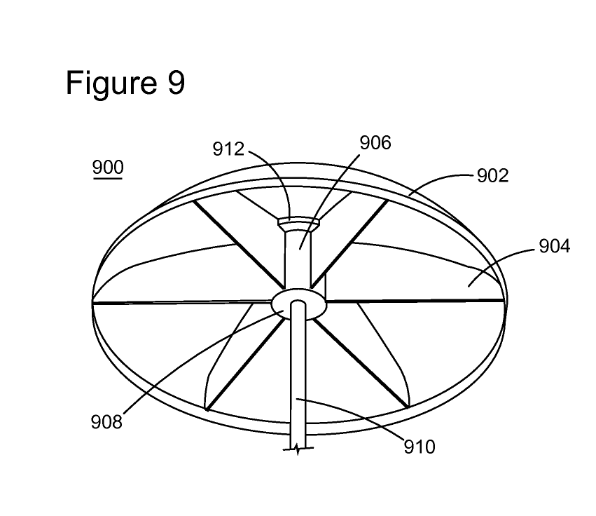

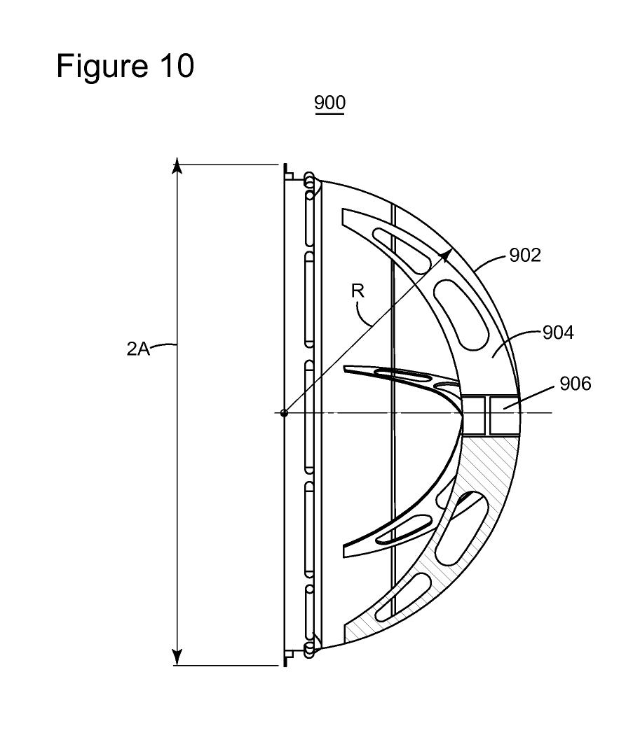

As an example intended to not limit the embodiments, FIGS. 9 and 10 show the shape of a piston 900 having its surface 902 supported by three diametric stiffeners 904. Note that in one embodiment, the three stiffeners intersect with each other at a central hub 906. Central hub 906 has a hole 908 for receiving a corresponding shaft 910. Central hub 906 may also have a plate 912 attached to a vertex of the piston.

To provide a more realistic estimate for the source element output, in one application, the piston's actual mass includes not only the mass of the piston itself (e.g., 132 in FIG. 1), but also the mass of the structure that moves with the piston (e.g., shaft 910 and plate 912). Note that plate 912 may not be as simple as a single plate, but may include plural elements, i.e., various plates and sensors.

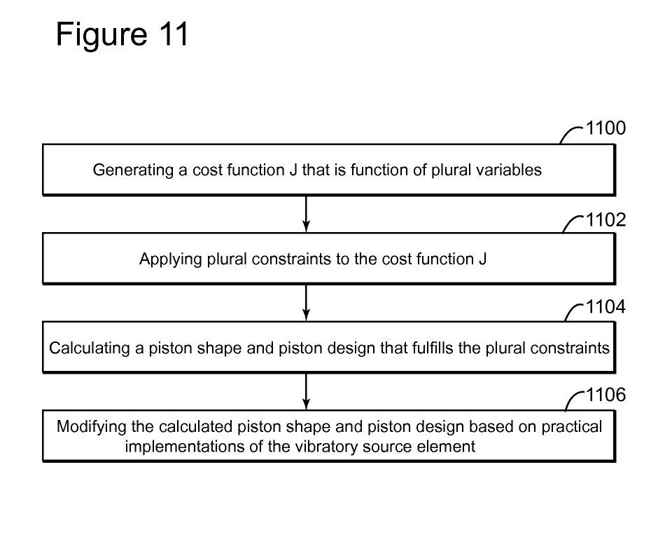

According to a method for determining a shape and structure of a piston for a vibratory seismic source element, as illustrated in FIG. 11, there is a step 1100 for generating a cost function J that is function of plural variables; a step 1102 of applying plural constraints to cost function J; a step 1104 of calculating a piston shape and design that fulfills plural constraints; and a step 1106 of modifying the calculated piston shape and design based on practical implementations of the vibratory source element. Cost function J may include the first cost function J₁ and the second cost function J₂ discussed above. As also discussed above, first cost function J₁ can be calculated first and second cost function J₂ can be calculated later.

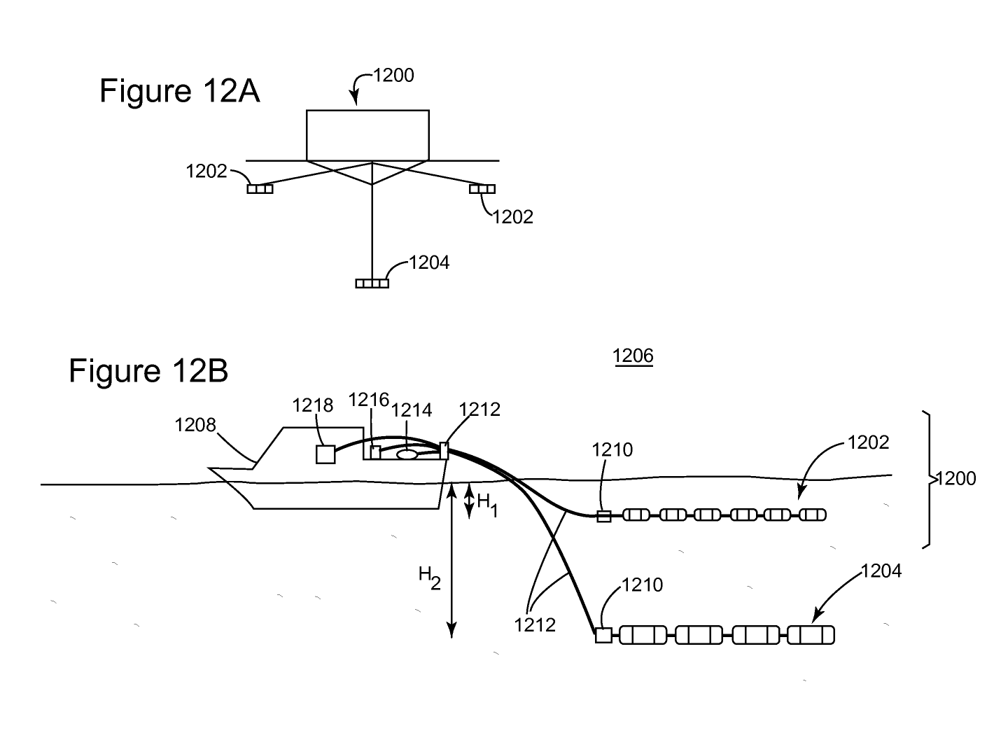

When implemented in a real seismic survey system, a seismic source array 1200 having the source elements discussed with reference to FIGS. 1, 2, 9 and 10 may have, as illustrated in FIG. 12A, two high-frequency sub-arrays 1202 and a single low-frequency sub-array 1204. Each sub-array may have plural source elements as discussed above. In one application, the high-frequency sub-arrays 1202 are towed at a depth of about 5 m, while the low-frequency sub-array 1204 is towed at a depth of about 25 m.

A side view of a marine acquisition system 1206 that includes seismic sources having pistons shaped and configured as discussed above is illustrated in FIG. 12B. System 1206 includes a towing vessel 1208 that tows the seismic array 1200. Seismic array 1200 may include, as discussed with regard to FIG. 12A, one or more high-frequency sub-arrays 1202 positioned at a depth H1 and one or more low-frequency sub-arrays 1204 positioned at a depth H2, where H2 is larger than H1. Each sub-array may include a source element as illustrated in FIGS. 1 and 2, and each source element may have pistons configured as illustrated in FIGS. 9 and 10. Depth controllers 1210 may be located on or next to each sub-array for maintaining a desired depth. Umbilicals 1212 connect each sub-array to vessel 1208. An umbilical may include a strength member, command and data capabilities, electrical power and pneumatic air supply.

A mechanical interface 1212 connects corresponding umbilical components to a pneumatic supply system 1214, a power supply system 1216, and a command and control device 1218. Command and control device 1218 may include a processing unit, as described later, capable of receiving and processing seismic data for imagining the surveyed subsurface. Command and control device 1218 may be also configured to control and adjust a trajectory of the seismic source, and control the shooting of the source elements. Command and control device 1218 may interact with the vessel's navigation system.

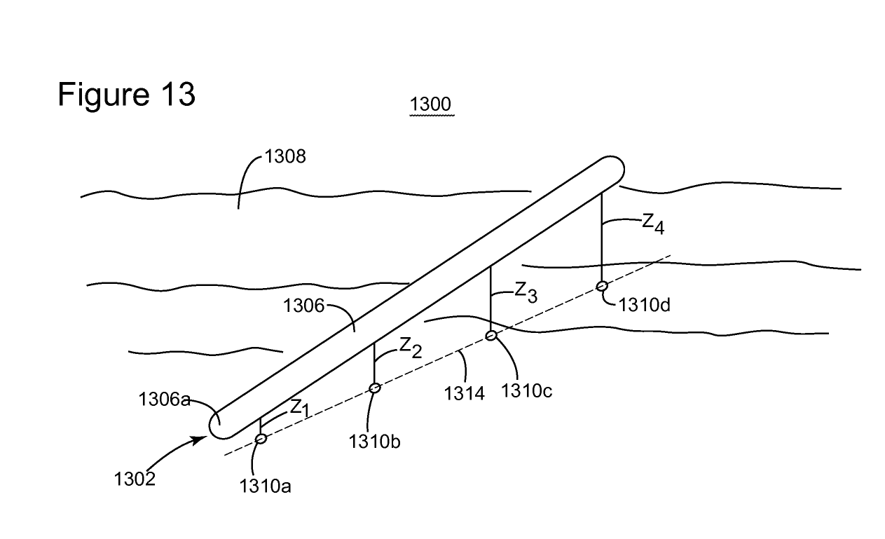

Although FIG. 12B shows each sub-array having a horizontal distribution, note that a multi-level source may be used instead of source array 1204. For example, a multi-level source 1300 is illustrated in FIG. 13 as having one or more sub-arrays. The first sub-array 1302 has a float 1306 configured to float at the water surface 1308 or underwater at a predetermined depth. Plural source elements 1310a-d are suspended from float 1306 in a known manner. A first source element 1310a may be suspended closest to head 1306a of float 1306, at a first depth z1. A second source element 1310b may be suspended next, at a second depth z2, different from z1. A third source element 1310c may be suspended next, at a third depth z3, different from z1 and z2, and so on. FIG. 13 shows, for simplicity, only four source elements 1310a-d, but an actual implementation may have any desired number of source points. In one application, because the source elements are distributed at different positions, they are not simultaneously activated so as to direct the array radiated energy in a preferred direction. In one embodiment, the high-frequency source elements are simultaneously activated in a flip-flop mode with the low-frequency source elements. In another embodiment, all source elements are simultaneously activated with uncorrelated, coded signals so the recorded seismic signals can be separated based on the source element that emitted that signal.

Depths z1 to z4 of the first sub-array 1302 source elements may obey various relationships. In one application, source element depth increases from the head toward the tail of the float, i.e., z1<z2<z3<z4. In another application, the source element depth decreases from the head to the tail of the float. In another application, the source elements are slanted, i.e., on an imaginary line 1314. In still another application, line 1314 is straight. In yet another application, line 1314 is curved, e.g., part of a parabola, circle, hyperbola, etc. In one application, the depth of sub-array 1302's first source element is about 5 m, and the greatest depth of the last source element is about 8 m. In a variation of this embodiment, the depth range is between 8.5 and 10.5 m or between 11 and 14 m. In another variation of this embodiment, when line 1314 is straight, source element depth increases by 0.5 m from one source element to an adjacent source element. Those skilled in the art would recognize that these ranges are exemplary, and these numbers may vary from survey to survey. A common feature of all these embodiments is that the source elements have variable depths so that a single sub-array exhibits multiple-level source elements. For example, the source elements for one sub-array may have a depth varying between 15 to 35 m.

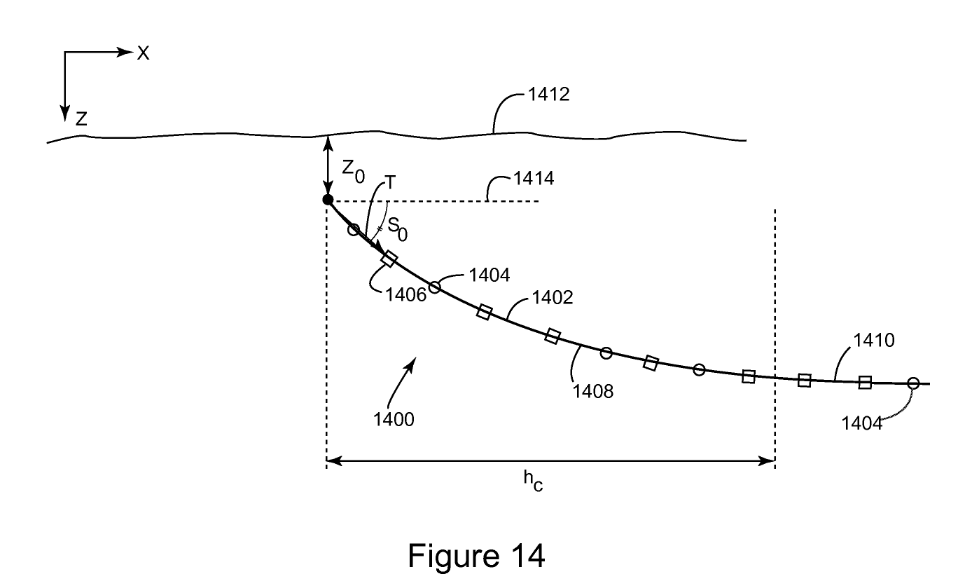

The above embodiments were discussed without specifying what type of seismic receivers is used to record the seismic data. In this sense, it is known in the art to use, for a marine seismic survey, streamers with seismic receivers that are towed by one or more vessels. The streamers may be horizontal, slanted or have a curved profile, as illustrated in FIG. 14.

Curved streamer 1400 of FIG. 14 includes a body 1402 having a predetermined length, plural detectors 1404 along the body, and plural birds 1406 along the body that maintain the selected curved profile. The streamer is configured to flow underwater when towed such that the plural detectors are distributed along the curved profile. The curved profile may be described by a parameterized curve, e.g., a curve described by (i) a depth z₀ of a first detector (measured from the water surface 1412), (ii) a slope s₀ of a first portion T of the body with an axis 1414 parallel with the water surface 1412, and (iii) a predetermined horizontal distance h_{c} between the first detector and an end of the curved profile. Note that not the entire streamer has to have the curved profile. In other words, the curved profile should not be construed to always apply to the entire length of the streamer. While this situation is possible, the curved profile may be applied only to a portion 1408 of the streamer. In other words, the streamer may have (i) only a portion 1408 having the curved profile or (ii) a portion 1408 having the curved profile and a portion 1410 having a flat profile, with the two portions attached to each other.

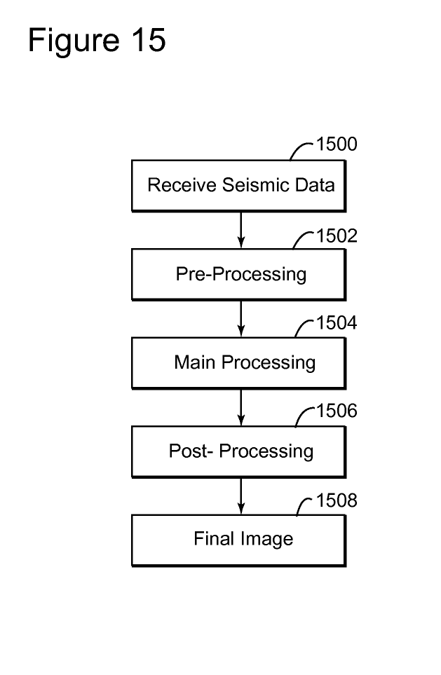

Seismic data generated by the seismic sources discussed above and acquired with the streamers noted in FIG. 14 may be processed in a corresponding processing device for generating a final image of the surveyed subsurface as discussed now with regard to FIG. 15. For example, the seismic data generated with the optimized source elements as discussed with regard to FIGS. 9 and 10 may be received in step 1500 at the processing device. In step 1502 pre-processing methods are applied, e.g., demultiple, signature deconvolution, trace summing, vibroseis correlation, resampling, etc. In step 1504 the main processing takes place, e.g., deconvolution, amplitude analysis, statics determination, common middle point gathering, velocity analysis, normal-move out correction, muting, trace equalization, stacking, noise rejection, amplitude equalization, etc. In step 1506 final or post-processing methods are applied, e.g., migration, wavelet processing, inversion, etc. In step 1508 the final image of the subsurface is generated.

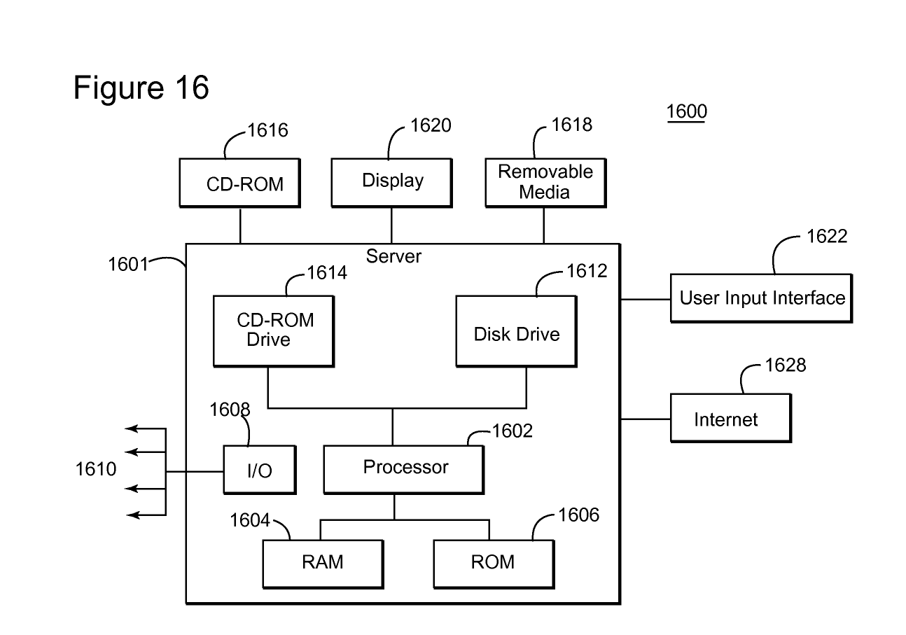

An example of a representative processing device capable of carrying out operations in accordance with the embodiments discussed above is illustrated in FIG. 16. Hardware, firmware, software or a combination thereof may be used to perform the various steps and operations described herein. The processing device 1600 of FIG. 16 is an exemplary computing structure that may be used in connection with such a system, and it may implement any of the processes and methods discussed above or combinations of them.

The exemplary processing device 1600 suitable for performing the activities described in the exemplary embodiments may include server 1601. Such a server 1601 may include a central processor unit (CPU) 1602 coupled to a random access memory (RAM) 1604 and to a read-only memory (ROM) 1606. The ROM 1606 may also be other types of storage media to store programs, such as programmable ROM (PROM), erasable PROM (EPROM), etc. Processor 1602 may communicate with other internal and external components through input/output (I/O) circuitry 1608 and bussing 1610, to provide control signals and the like. For example, processor 1602 may communicate with the sensors, electro-magnetic actuator system and/or the pressure mechanism of each source element. Processor 1602 carries out a variety of functions as are known in the art, as dictated by software and/or firmware instructions.

Server 1601 may also include one or more data storage devices, including disk drives 1612, CD-ROM drives 1614, and other hardware capable of reading and/or storing information, such as a DVD, etc. In one embodiment, software for carrying out the above-discussed steps may be stored and distributed on a CD-ROM 1616, removable media 1618 or other form of media capable of storing information. The storage media may be inserted into, and read by, devices such as the CD-ROM drive 1614, disk drive 1612, etc. Server 1601 may be coupled to a display 1620, which may be any type of known display or presentation screen, such as LCD, plasma displays, cathode ray tubes (CRT), etc. A user input interface 1622 is provided, including one or more user interface mechanisms such as a mouse, keyboard, microphone, touch pad, touch screen, voice-recognition system, etc.

Server 1601 may be coupled to other computing devices, such as the equipment of a vessel, via a network. The server may be part of a larger network configuration as in a global area network (GAN) such as the Internet 1628, which allows ultimate connection to the various landline and/or mobile client/watcher devices.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized, including hard disks, CD-ROMs, digital versatile discs (DVD), optical storage devices or magnetic storage devices such a floppy disk or magnetic tape. Other non-limiting examples of computer-readable media include flash-type memories or other known types of memories.

The disclosed exemplary embodiments provide a source array, seismic vibro-acoustic source element and a method for finding an optimized shape for a piston of an acoustic marine source element. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for determining a shape and structure of a piston for a vibratory seismic source element, the method comprising:
generating a cost function J that is function of plural variables;
applying plural constraints to the cost function J;
calculating a piston shape and piston design that fulfills the plural constraints; and
modifying the calculated piston shape and piston design based on practical implementations of the vibratory source element.

2. The method of claim 1, wherein the plural variables include a radius of curvature of the piston, a number of stiffeners that enforce the piston, a thickness of the stiffeners, and a material from which the piston is made.

3. The method of claim 2, wherein the plural constraints include (i) minimization of an actual mass of the piston that includes all parts rigidly attached to the piston, and (ii) maximization of seismic energy generated by the piston.

4. The method of claim 1, wherein the cost function J includes a radiation mass of the piston and an actual mass of the piston that includes all parts rigidly attached to the piston, wherein the radiation mass acts as a fluid mass added to the piston.

5. The method of claim 4, wherein the radiation mass is given by an imaginary part of a mechanical radiation impedance of the piston, the mechanical radiation impedance of the piston being defined as a ratio of an applied force and a velocity of the piston.

6. The method of claim 1, wherein the shape of the piston is a part of a sphere and a best curvature radius (R) of the piston is between 0.9 A and 1.3 A, where A is a radius of a projection of the piston in a plane.

7. The method of claim 6, wherein the material for the piston for a low-frequency source element is stainless steel and composite for a high-frequency source element.

8. The method of claim 7, wherein the number of stiffeners is about 3 for the low-frequency source element and zero for the high-frequency source element, wherein a low frequency range is between zero and 50 Hz and a high frequency range is between 25 and 150 Hz.

9. The method of claim 8, wherein the shape of the piston is a part of a sphere and a best curvature radius (R) of the piston is A, where A is a radius of a projection of the piston in a plane.

10. The method of claim 1, wherein the practical implementations include resistance to corrosion, welding capabilities, and cost of materials.

11. The method of claim 1, wherein the cost function J includes a first cost function J1 and a second cost function J2, wherein the first cost function J1 determines the radius of curvature of the piston and the second cost function J2 determines a number of stiffeners, a thickness of stiffeners, a type of material for the piston and a thickness of the piston.

12. The method of claim 11, wherein the first function J1 is optimized first and the second function J2 is optimized later based on results from the first function J1.

13. A method for determining a shape and structure of a piston for a vibratory seismic source element, the method comprising:
generating first and second cost functions J₁ and J₂;
applying first and second constraints to the first and second cost functions J₁ and J₂, respectively;
calculating first a piston shape that fulfills the first constraints;
calculating second a structure of the piston that fulfills the second constraints and
modifying the calculated piston shape and piston structure based on practical implementations of the vibratory source element.

14. The method of claim 13, wherein the first cost function includes as a variable a radius of the piston, and the second cost function includes as variables a number of stiffeners that enforce the piston, a thickness of the stiffeners, and a material from which the piston is made.

15. The method of claim 14, wherein the first constraints include minimization of an actual mass of the piston, and the second constraints includes a maximization of seismic energy generated by the piston.

16. The method of claim 13, wherein the first and second cost functions include a radiation mass of the piston and an actual mass of the piston and all structure that is rigidly attached to the piston, wherein the radiation mass acts as a fluid mass added to the piston.

17. The method of claim 16, wherein the radiation mass is given by an imaginary part of a mechanical radiation impedance of the piston, the mechanical radiation impedance of the piston being defined as a ratio of an applied force and a velocity of the piston.

18. The method of claim 16, wherein the actual mass of the piston is given by a real part of the mechanical radiation impedance of the piston, the mechanical radiation impedance of the piston being defined as a ratio of an applied force and a velocity of the piston.

19. A method of seismic acquisition comprising:
using a plurality of source elements in which at least one source element is equipped with an underwater acoustic piston having a stiff convex shell that has been optimized to reduce the combined driven mass, wherein the driven mass includes a combined structural actual mass and a radiation mass;
shooting the at least one source element;
recording seismic data generated by the at least one source element; and
generating an image of a surveyed subsurface.

20. The method of claim 19, wherein the underwater acoustic piston is driven axially and has a radius of curvature within a range of 0.9 A to 1.3 A, where A is a radius of a projection of the piston in a plane.
